(19) United States
(12) Patent Application Publication
(10) Pub. No.: US 2026/0350950 A1
(43) Pub. Date: Nov. 5, 2026

(54) METHOD AND APPARATUS FOR PRODUCING RENDERINGS FROM 3D MODELS USING GENERATIVE MACHINE LEARNING

(71) Applicant: The Regents of the University of California, Oakland, CA (US)

(72) Inventor: Kyle STEINFELD, Berkeley, CA (US)

(21) Appl. No.: 19/488,493

(22) PCT Filed: Jun. 17, 2024
(86) PCT No.: PCT/US2024/034265

§ 371 Date: Nov. 26, 2025

Related U.S. Application Data
(60) Provisional application No. 63/511,330, filed on Jun. 30, 2023.

(51) Int. Cl. G06T 19/20; G06T 15/04; G06T 15/10; G06T 17/00

(52) U.S. Cl. CPC G06T 19/20; G06T 15/04; G06T 15/10; G06T 17/00; G06T 2200/24; G06T 2210/04; G06T 2219/2012; G06T 2219/2024

(57) ABSTRACT

A system for producing a rendering from a 3D model includes a semantic material assignment module, a map derivation module and an image synthesis module. The semantic material assignment module receives a user-provided geometric model and assigns semantic information to elements of the geometric model based on textual user input data: The map derivation module receives the geometric model with semantic information assigned, and receives a user-provided virtual camera and produces a semantic map. The image synthesis module receives the semantic map and produces a synthetic image using a conditional image synthesis process, based on user input data.

### CROSS REFERENCE TO RELATED APPLICATION

This application claims the benefit of U.S. Provisional Application No. 63/511,330, filed Jun. 30, 2023, the contents of which are incorporated herein by reference.

### FIELD OF THE INVENTION

The invention relates generally to the field of 3D computer graphics and computer rendering, and more particularly to the application of rendering in domains that employ computer renderings and that rely on the rapid and precise visualization of design options, such as architectural design, product design, experience design, interior design, and industrial design.

### BACKGROUND

Rendering is a prominent subfield within the realm of 3D computer graphics and is highly interrelated with other subfields as it represents the final stage in what is known as the 3D “graphics pipeline”, which determines the ultimate visual characteristics of 3D renderings. Across the past 50 years of advancement in computer graphics, rendering has evolved into a distinctive area of study and has benefited from a series of progressive and ongoing advancements The applications of rendering encompass a broad range of application domains ich domain employs a unique combination of features and techniques, tailored to their specific requirements and objectives.

Generative machine learning (GML) is a subfield of machine learning (ML) focused on the production of synthetic data samples that mimic given training data. One specific application of GML is conditional image synthesis, wherein the generation of synthetic images is guided by certain user-defined conditions. While GML systems can generate images sed on a variety of user inputs, they have not yet been able to relate the generation o se images with 3D models in a manner that meets the needs of the domains of application described above.

### SUMMARY

In one aspect, the present disclosure provides an application of generative machine learning (GML) for the production of semantically-guided visualizations of 3D models.

Existing approaches to visualizing 3D models are capable of producing highly detailed representations that offer users a great deal of compositional control, but these also require a significant amount of time and expertise to create and configure. While recent developments in generative machine learning have brought about systems that are capable of quickly producing convincing synthetic images of objects, people, landscapes, and environments without the need for a 3D model, these are also difficult to precisely control and compose, and cannot be directly related to detailed 3D models with the fidelity required for a range of applications. By integrating GML into 3D modeling and visualization workflows, the method described here streamlines the visualization process by eliminating arduous and time-consuming aspects while maintaining important points of user control.

In contrast with traditional approaches to 3D model visualization, in the approach described herein significant portions of the typical process are no longer required. Important to the present disclosure is the concept of a “semantic material”—an approach that calls for relating geometric elements in a 3D scene with user(s)-provided descriptions of how these elements are intended to appear in a rendering. Specifically, this approach allows for the associating of both geometric and non-geometric elements of a 3D model with semantic information for the derivation of data based upon this semantic information, and for a framework by which this data may assert control over a GML-based conditional image synthesis process. The subject matter described herein couples the detailed compositional control offered by 3D models with the unique facility arising from defining the visual properties of geometry using natural language.

In one particular embodiment, a system of producing a rendering from a 3D model is provided. The system includes a semantic material assignment module that, when executed by one or more processors, receives a user-provided geometric model, and assigns semantic information to elements of the geometric model based on textual user input data. A map derivation module is provided that, when executed by one or more processor, receives the geometric model with semantic information assigned, and receives a user-provided virtual camera, and produces a semantic map. An image synthesis module is also provided that, when executed by one or more processors, receives the semantic map, and produces a synthetic image using a conditional image synthesis process based on user input data.

In another particular embodiment, a system is provided for producing a rendering from 3D models The system includes a geometric modeling module for producing a geometric model based on first user input data. A semantic material assignment module is provided that, when executed by one or more processors, receives the geometric model, and assigns semantic information to elements of the geometric model based on textual user input data. A camera configuration module is provided that, when executed by one or more processors, receives the geometric model, and produces a virtual camera based on user input data; A map derivation module is provided that, when executed by one or more processors, receives the geometric model with semantic information assigned, and receives the virtual camera, and produces a semantic map and produces one or more supplemental non-semantic maps such as a depth map, edge map, and/or a traditionally-rendered image. An environmental prompt module is provided that, when executed by one or more processors, produces a prompt that describe s the general style-based features to be reflected in the rendering, such as the overall lighting, mood, and style, based on user input data. An image synthesis module is provided that, when executed by one or more processors, receives the semantic map, the supplemental non-semantic maps, and any prompts, and produces a synthetic image using a conditional image synthesis process, based on user input data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 is a functional block diagram illustrating a system implementing a conventional visualization process supported by current state-of-the-art 3D modeling systems.

FIG. 2 is a block diagram illustrating a system implementing a conventional image synthesis process supported by current state-of-the-art generative machine learning systems.

FIG. 3 is a block diagram illustrating a system implementing a conventional conditional image synthesis process supported by current state-of-the-art generative machine learning systems.

FIG. 4 is a functional block diagram illustrating one example of a system for implementing a visualization process in accordance with the subject matter described herein, which integrates generative machine learning systems into, e.g., computer-aided design systems, to support semantically-guided visualizations of 3D models.

FIG. 5 is a functional block diagram illustrating an alternative embodiment of a system for implementing a visualization process in accordance with the subject matter described herein.

FIG. 6 illustrates exemplary user interfaces for two scenarios, one of which exemplifies a user interface for assigning semantic information to 3D geometry at the object level and the other of which exemplifies a user interface for assigning semantic information to 3D geometry at the sub-object level.

FIG. 7 illustrates exemplary ser interfaces for a scenario in which a user assigns semantic information to 3D geometry at the texture level.

FIG. 8 illustrates an exemplary user interface for a scenario in which a user assigns semantic information to the overall environment described by a 3D scene.

FIG. 9 illustrates four categories of maps (a semantic map with two semantic regions, a semantic map with three semantic regions, and edge map and a depth map) produced by a 3D modeling system in order to guide image synthesis by a generative machine learning system.

### DETAILED DESCRIPTION

### Introduction

In one aspect, the subject matter described herein offers an alternative to existing methods in producing renderings from 3D models, methods that are employed across a broad range of fields. Such fields include, without limitation, architectural design, product design, experience design, interior design, industrial design, visual effects (VFX) production, motion graphic design, game development, and production design for film and television, which rely on the rendering of 3D models to produce a single image sequence of images (as in the production of an animation or a movie), of interactive interface with a 3D model (as in a video game).

The following discussion of 3D computer graphics and generative machine learning is useful to facilitate an understanding of the systems and methods described herein.

### 3D Computer Graphics

3D models are used in design fields across the design process: from early-stage concept design, to the development and evaluation of schematic design options, to the refinement of the details of finalized design proposals. In each of these stages, the expectations and applications of 3D models in the design process are expressed differently. For example, in early stages designers may require only roughly-modeled geometry that is quick to visualize and iterate over, while in later stages a designer may more strongly value a precisely-modeled form that is precisely rendered. Fields outside of design also require the modeling and rendering of 3D information. For example, 3D models are commonly used in the production of visual effects for film and television, and similar modeling and rendering operations are crucial components of video game development.

The act of computer rendering involves utilizing a computer program to generate an image, which may be either photorealistic or non-photorealistic. Using existing methods, this image is derived from information stored in a “3D scene”, which includes geometric information stored in a 3D model combined with non-geometric features that drive the nature of the visualization such as a virtual camera, virtual lights, etc. The act of calculating this image is typically referred to as the “rendering” of a scene, and the image that results is also commonly known as a “rendering” or the “render”. Intended results may include a realistic image that appears to be a photograph, or a stylized image that resembles an illustration, painting, or hand-drafted representation.

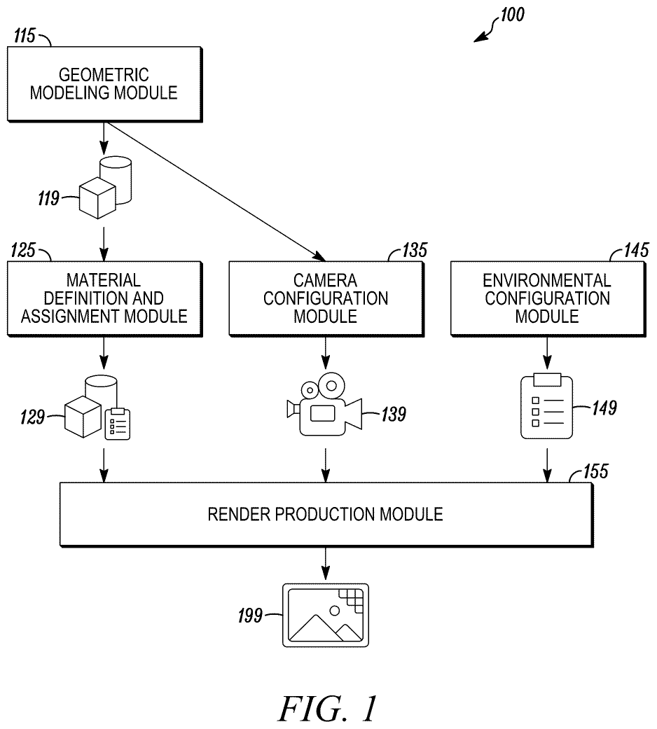

FIG. 1 is a functional block diagram illustrating a system implementing a conventional visualization process supported by current state-of-the-art 3D modeling systems. In FIG. 1 and the figures that follow, like elements are denoted by like reference numerals. Furthermore, the elements depicted in the functional block diagrams or any other logical component may be implemented on a machine capable of executing program instructions. Thus, while the drawings and descriptions herein set forth functional aspects of the disclosed systems, no particular arrangement of hardware or software for implementing these functional aspects should be inferred from these descriptions unless explicitly stated or otherwise clear from the context.

Referring again to FIG. 1. the production of a typical visualization proceeds through a sequence of functional modules 100 that perform a series of operations. such as: the definition of the objects or environments to be visualized, the configuration of those features of the 3D scene that affect the visual result, and the adjusting of certain details of the process by which the final rendered image is computed. In broad strokes, the following functional modules ire typically employed.

The geometric modeling module 115 produces a set of geometric elements that represent the forms and composition of objects and environments to be rendered. These geometric elements 119 are passed on to subsequent processes, and may be stored in a variety of data structures (e.g., rational surface models, polygon meshes, NURBS, subdivision surfaces). In some applications, these geometric elements include a description of transformations over time—which may range in complexity from simple translations of position and orientation, to complex set changes for a “rigged” character model—that are related to the production of a sequence of renderings that constitute an animation. In some applications, such as those found in video game applications, the configuration of geometric elements may be the result of both the configuration of an interactive system (e.g. the game) and actions performed by users of this system (e.g. the players).

The material definition and assignment module 125 defines features of given geometric elements (e.g. surface color, reflectivity, transparency, texture, and bumps) that affect the manner in which these elements appear in the visual result. Given a set of geometric elements without such features 119, this module is responsible for producing elements with visual features assigned 129 and stored in a variety of data structures.

The camera configuration module 135 defines a virtual camera, thereby defining those features that affect the point of view from which the scene is imaged (e.g. position, orientation, depth of field, lens length). These features are typically encoded as a set of properties that define a virtual camera object 139 The definition of a virtual camera is among the set of non-geometric values that distinguish a 3D scene from a 3D model. In the context of a designer producing a single rendering of a candidate design, a virtual camera defined in a single position and orientation is typically sufficient. For applications that require a collection of renderings to be produced as an animation (such as a movie), certain properties of this virtual camera must be defined as a sequence of values that transform over time. For applications that involve an interactive system (such as a video game), the properties of this virtual camera may be defined both by the configuration of the interactive system (e.g. the game) and actions performed by users of this system (e.g. the players).

The environmental configuration module 145 supports the definition of features that affect the manner in which the overall environment is imaged (e.g. lighting, reflections, refractions, caustics, motion blur, and the nature of the participating medium such as fog). These features are among the set of non-geometric values that distinguish a 3D scene from a 3D model, and are typically expressed as a set of properties that define virtual lights and environmental illumination 149. For applications that require renderings produced as an animation, these properties may be defined as a sequence of values that transform over time. For applications that involve an interactive system, these properties may be defined both by the configuration of the interactive system and actions performed by users of this system.

The render production module 155 allows users to make render process-based choices (e.g. density of rasterization, number of light bounces to calculate) that determine the manner in which the visual result is calculated, and that are closely related to approach to image calculation that is selected (e.g. rasterization, ray tracing, ray casting, etc). This module is responsible for producing the final rendering 199. For applications that require renderings produced as an animation, these process-based choices may be defined as a sequence of values that transform over time. For applications that involve an interactive system, these process-base nay be defined both by the configuration of the interactive system and actions performed by users of this system.

The modules described above are expressed differently across different professional applications—rendering 3D models in the context of visual effects for animation, for example, would be expressed differently than rendering 3D models in the context of product design. The modules for a given application would include a distinct set of user interface elements, data formats, and processing requirements. To further illuminate the process of rendering a 3D model, an example of these modules in the context of a specific application domain will be presented below. This set of modules considers the case of computer-aided design (CAD), and outlines how the basic functional modules may be expressed in support of a typical design process.

In the geometric modeling module 115, a geometric model is created which may include 2D and/or 3D information. This functional module is the primary focus of a variety of existing CAD software, across which the re are a variety of user interface schema and a wide range of data structures. Some geometric formats are strongly related to features of the rendering process. These include procedurally generated geometry such as fur, hair, and particle-based effects, for example.

From the CAD user's point of view, the defining and composing of the relationship of 2D and 3D geometric information is an important aspect of the production of a visualization. The objects and environment described by the geometry of the scene typically comprise the primary subject of the rendering. In the case of 3D modeling in the context of design, the scene geometry typically represents a candidate design—the object under consideration that is being evaluated for its suitability as a part of a larger design process

In the material definition and assignment module 125, object, sub-object, and textural features are determined. The output of this functional module is highly determinative of the way objects and sub-objects appear in the final visualization. At the object and sub-object levels, this may include the designation of colors, patterns, textures, and other properties that affect the way in which light interacts with geometry in the scene. Often this proceeds through the definition of an aggregation of such properties into collections that are referred to as “materials” These materials may then be assigned to objects and/or sub-objects in the scene. Materials may be created using a variety of methods, such as painting them by hand, using procedural textures, or scanning real-world objects. Some materials may define properties that change across the object to which they are assigned, such as ones that describe a pattern of color or texture. Changes across a surface may be generated procedurally, but are more typically described using raster data which must then be related to geometric features of objects in the scene This relationship is often described as a “texture map” or “UV mapping” in which pixels in the raster data are related to geometric locations on the target surface (typically to a vertex on a polygon mesh). Some object and sub-object material features are strongly related to features of the rendering process that is employed by later modules (e.g. transparency, translucency, reflectivity, and caustics).

From the CAD user's point of view, the definition and assignment of object and sub-object features is a laborious task that typically requires a large investment of time. Even for a skilled user of 3D modeling software, the determination of these features is often the most challenging and labor-intensive aspect of creating a rendering.

The camera configuration module 135 determines the point of view from which the scene is imaged. A crucial element of the composition of a rendering concerns the configuration of the viewpoint from which a scene is depicted. Most often this proceeds through the defining of a virtual camera 139, which offers control over features such as the field of view, focal length, depth of field in addition to the camera position and orientation that determines the viewpoint reflected in the final rendering.

From the CAD user's point of view, the configuration of a virtual camera holds a major impact on the final rendered image, and strongly drives the nature of the visual result. After the composition of 3D geometry, features related to the virtual camera are among the most highly valued by users as they hold an outsized influence over the visual result and offer an important point of compositional control.

In the environmental configuration module 145, those features of the 3D scene that are not directly related to 3D geometry are determined. This functional module determines the manner in which the overall environment of a scene is imaged While typically not the subject of the rendering, features related to the visual environment of the scene of a 3D rendering (e.g. lighting, background, environmental effects) strongly affect the manner in which the environment is imaged, and hold a strong influence on the “look” of the resulting render Prominent among these features are those related to the source of light in a scene and the manner in which light interacts with objects. This includes the determination of environmental illumination (e.g. skydome lighting, global illumination, raster-based lighting), source illumination (e.g. point lights, spot lights, emissive objects), and lighting effects and behavior (e.g. ambient occlusion, and volumetric lighting effects such as simulated fog or dust)—all of which must define basic properties such as light intensity, color, and position.

From the CAD user's point of view, non-geometric features of a 3D scene have a major impact on the final rendered image, and strongly drive the nature of the visual result. Despite the importance of such features, the expertise to effectively configure them is held only by a narrow subset of users, such as visualization specialists. As such, the effective configuration of non-geometric features is a common “pain point” for many people.

In the render production module 155, render-process-based features are determined. This functional module produces a visualization of the 3D scene based upon settings determined by previous modules. Once all of the above features of the scene are determined, the calculation of the final rendered image may proceed. This process is the subject of a prominent subfield within the realm of 3D computer graphics, and a number of approaches have been developed and refined across the past 50 years. In broad strokes, there are two main approaches to rendering, each of which requires a different set of configuration decisions. The more basic approach to rendering is “rasterization”, which works by projecting 3D geometric features onto a 2D plane set by the position of the camera, then determining which pixels are covered by each geometric element, and then filling those pixels with the appropriate color. This technique relies on the use of shaders to determine the appearance of each geometric element and how it interacts with light sources. A more accurate, but also more computationally expensive, approach is “ray tracing”, which works by tracing the path of individual rays of light as they interact elements in the scene, often by casting rays from each pixel in the camera viewport. A host of different algorithms have been developed to support this process, which are sometimes referred to as “render engines” when implemented in commercial software. Some of these engines are valued for their speed (e.g. rasterization-based: approaches operate as a simple geometric projection of elements to a view plane with few optical effects) while others are valued for their ability to accurately produce realistic rendered images (e.g. raycasting- and raytracing-based approaches are designed as simulations of how light moves through space, interacts with surfaces, and strikes a virtual camera). The rendering process can take a long time, depending on the complexity of the scene and the power of the computer.

From the CAD user's point of view, the determination of render-process-based features can be challenging. Rendering engines are sophisticated software components that involve complex algorithms and settings to achieve desired results. They often have a wide range of parameters and options that control various aspects of the rendering process. Understanding and effectively manipulating these parameters require a good understanding of the underlying rendering techniques and their interactions. A typical user of CAD software may not be familiar with the technical intricacies of a rendering engine, which are specialized tools that require specific knowledge and experience to operate efficiently. For this reason, many users rely upon standard configurations and simplified interfaces when determining render-process-based features.

Even in the particular case of computer-aided design (CAD) applications, the set of modules described above do not need to be followed in sequential order. For instance, since the process of design is iterative in nature, it is common to find designers moving cyclically through these activities, often starting with “rough” decisions implemented in one step, which are then refined over time through understanding results in related steps by making small adjustments in parallel. The process of visualization in a CAD context is detailed here as an illustration. In different professional applications the process described above would include a similar set of functional modules, but expressed differently.

### Generative Machine Learning

In one aspect, the subject matter described herein employs generative machine learning (GML) for the production of text-guided visualizations of 3D models. While recent developments in GML-based image synthesis have brought about systems capable of synthesizing images given a range of user input conditions (e.g. text prompts, an image style reference, a semantic layout or semantic segmentation map, other task-specific conditions such as edge maps (or sketches) or depth maps, and combinations of these conditions), these systems fail to fully address the visualization needs of many users. Specifically, they fail to support users need to relate synthesized images to 3D geometry at the level of fidelity required by a range of application domains.

Machine learning (ML) is a field of artificial intelligence (A) that focuses on developing algorithms and models that enable computers to learn and make predictions or decisions based on data without being explicitly programmed. Generative machine learning refers to a branch of ML that focuses on creating models that can generate new, synthetic data samples that resemble given training data. These models learn the underlying patterns and structure of this data during the training process, and can then generate new samples that are similar to the original data. One application of GML is “image synthesis”—the process of gene new images that could conceivable real, even though they are entirely generated by a machine. When the generation of such images is guided by one or more user-defined conditions, this is referred to as “conditional image synthesis”. Conditional image synthesis systems are of particular interest here, as such systems are required to create an image in relationship to information derived from a 3D model.

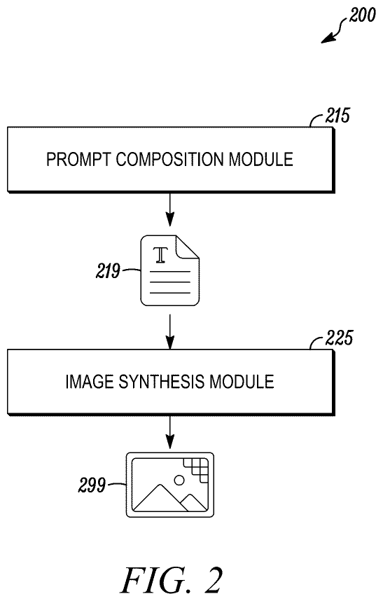

Despite the variety of approaches to image synthesis recently developed, the most visible rent innovations in conditional image synthesis have focused on one category of user-provided conditions: text. Text-guided image synthesis systems (often referred to as “text-to-image”or TTI systems) operate as shown in FIG. 2. Broadly speaking, most state-of-the-art TTI systems 200 operate in roughly the same way. A single user-facing functional module, the prompt composition module 215, produces a single short piece of text from user input. This text, termed a “prompt” 219, describes the intended image. A prompt is primarily natural language text, but may be semi-structured if the system alloy certain specifications to be included such as image dimension, proportion, or the relative weightings of various elements of the prompt. The image synthesis module 225 takes the prompt as input and produces one or more synthetic images 299 that match it. Generally, and with the exceptions described below that are relevant in the context of 3D modeling, a prompt is assumed to describe the desired image as a whole (rather than refer to spatially-distinct portions of the image). A major problem in current TTI systems is “spatial consistency”, that is: the problem of generating synthetic images that are consistent with the spatial relationships described in the text prompt. For example, if the text prompt describes a scene with a specific relationship—e.g. “a red mug sitting on a blue ball”—the model might generate objects with different spatial relationships—e.g. a red ball sitting next to a blue mug. The lack of spatial consistency presents acute challenges to the application of TTI, since many users place a high value on the defining and composing of geometric relationships. Some TTI systems allow for various forms of raster data as a supplement to, or in lieu of, a text prompt in order to guide the generation of the synthetic image. The role of this user-provided raster data varies from system-to-system. Some systems use this data in order to partially address spatial consistency challenges, while others use this data to guide stylistic aspects of the synthetic image.

Although text-guided conditional image synthesis systems have enjoyed the preponderance of recent innovation, a number of related developments have brought non-textual guidance to bear on synthetic image generation. Some of these take the form of user-provided raster data, or “maps”, that offer various forms of control over the generation of a synthetic image. A number of such map-guided conditional image synthesis systems hold relevance in the context of applications in 3D modeling and rendering, in particular: depth maps, edge maps, normal maps, and semantic maps. Each of these is expressed as raster data that affords pixel-wise control over the result: a depth map represents a description of the intended distance to objects in a scene, an edge map represents a description of important edges (as in a line drawing), and a semantic map describes a segmentation of the desired synthetic image into visual regions each of which is associated with a distinct prompt or portion of a prompt. In some implementations of map-guided image synthesis, maps are composable—that is, they may be used individually, in combination (e.g. a semantic map and a depth map may together guide the generation an image), or in conjunction with a prompt. Contemporary diffusion-based systems offer a different sort of map—and may provide for user-provided raster data in the form of an “initialization image” that is employed at the start of the diffusion process, and guides the intended result in a different way. Relative to the raster maps described above, this “initialization image” holds a different position in the generation process—serving the initial state of a de-noising process. From a user's perspective, this distinction makes little difference, and for the purposes of this discussion an “initialization image” may be considered as a special type of map in image-guided conditional image synthesis.

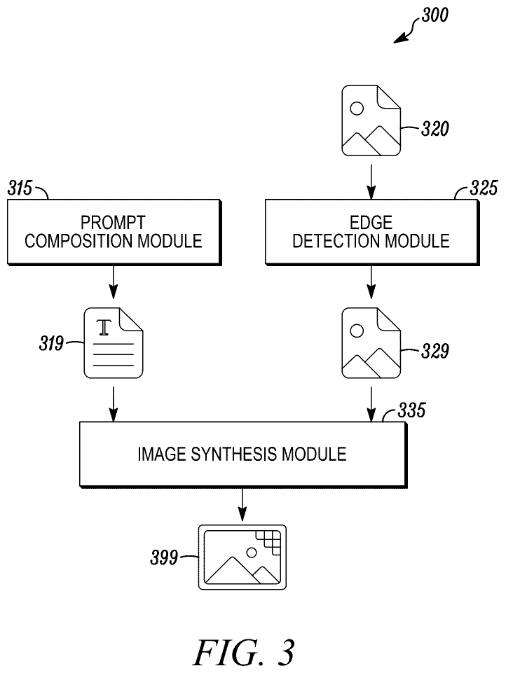

From the perspective of an end-user, creating a visualization using conditional image synthesis systems is similar to the TTI process described above. To illustrate, in the system 300 shown in FIG. 3, which combines a prompt with an edge map in the guidance of a synthetic image, the process would proceed as such: As in TTI systems, a prompt composition module 315 facilitates the composition of a single short piece of text, termed a “prompt”, which describes the intended synthetic image 319. Operating in parallel with this module is the edge detection module 325. This module is given an input image 320 which serves as the basis of an edge extraction calculation and produces raster data that describes the important visual boundaries found in the given image. This raster data is termed an edge map 329, which may be used in subsequent processes. In contrast with TTI, the image synthesis module 335 requires two inputs—a text prompt and a raster edge map—in order to produce one or more synthetic images 399.

Generative machine learning has been applied to 3D modeling tasks. Particularly relevant are developments relating to the GML-supported visualization of objects and environments composed as 3D models. While the systems and methods described herein may be applied to a wide range of fields, design-related applications will be discussed below. Looking specifically at applications in design fields, text-guided image synthesis systems are employed relatively widely, but most of the current applications among designers are not related to 3D models. While existing TTI systems were not designed with computer-aided design (CAD) applications in mind, designers from across a range of disciplines have found some utility for this technology. Most notably, existing text-to-image systems are valued by designers for their capacity to produce visualizations of design ideas without the need for creating a 3D model. Use cases that are well-supported by existing TTI systems tend to lie in the early stages of a design project, when designs are less constrained and specific spatial and geometric relationships have not yet been defined. Similarly, most of the current applications of map-guided image synthesis systems among designers are not related to 3D models. In most cases, maps intended to guide the generation of a synthetic image are either manually “painted”, or derived from a source image as a pre-processing step. For example, an image segmentation process may be applied to a source image to generate a semantic map, which may then serve to guide the generation of a synthetic image. While map-guided image synthesis systems were not intended to directly relate synthesized images to 3D models, there a examples of depth maps and edge maps extracted from 3D models and used in such a capacity. Recently, an approach of configuring and directly connecting 3D models to map-guided image synthesis systems has been implemented as plug-in software for a variety of 3D modeling software. In contrast with the systems and methods described herein, these existing implementations employ a purely map-guided approach, with text-guided image synthesis operating only at the level of the scene as a whole. Further, they do not account for semantic maps not include interface patterns for integrating semantic information into 3D models at the object, sub-object, and scene levels.

### Rendering System

Although certain aspects of generative machine learning have found application in design for the production of visualizations without the need for a 3D model, geometric digital models continue to hold value for many users. The systems and methods described herein support users by integrating GML-based conditional image synthesis systems with traditional visualization processes. The integration of image synthesis with 3D modeling workflows streamlines the visualization process by eliminating arduous and time-consuming aspects while maintaining important points of user control. The systems and methods described herein are significantly different both from traditional approaches to producing renderings from 3D models, and from state-of-the-art approaches to GML-based image synthesis.

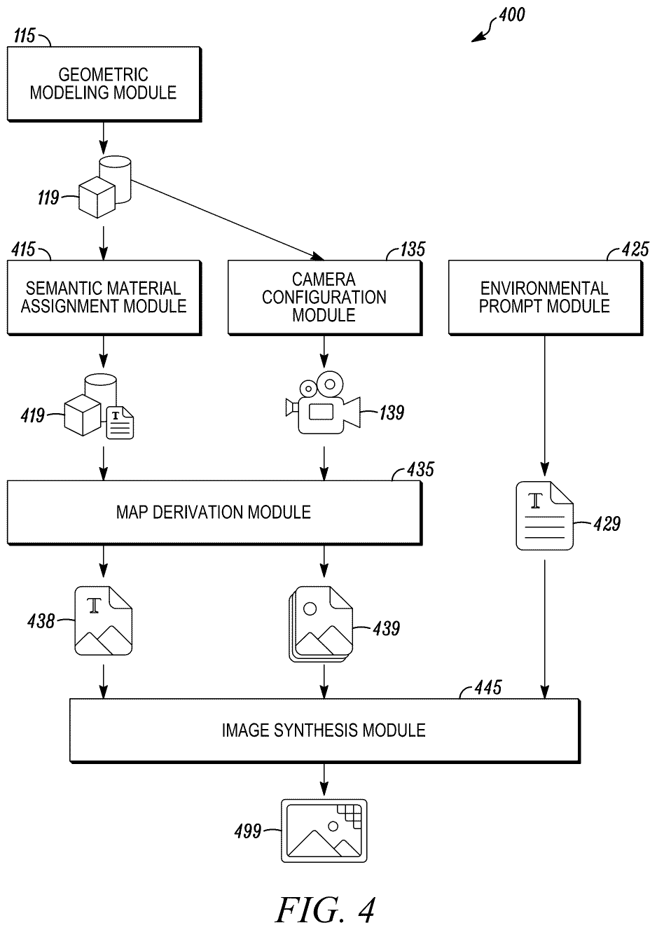

In particular, in contrast with traditional approaches to 3D model visualization, significant portions of the typical process are no longer required. Two functional modules in particular are essentially rendered obsolete—the material definition and assignment module 125 and the environmental configuration module 145 shown in FIG. 1. These modules are replaced by entirely new modules—a semantic material assignment module 415 (see FIG. 4) and an environmental prompt module 425 (see FIG. 4)—that relate geometric and non-geometric elements of the scene with textual prompts. Further, the render production module 155, which is technically intricate and challenging for users to configure, is replaced by an image synthesis module 445 transferred from GML-base d systems, which is partially guided by natural language prompts.

In contrast with state-of-the-art approaches to GML-based image synthesis, neither text-based prompts nor manually-produced maps are the sole mechanisms that guide the generation of images. Instead, points of compositional control important to users—such as those that define the visual features of objects, the spatial relationships between objects in the scene, and the features of the overall visualization including leas length and atmospheric effects—are directly defined as semantic information embedded into a 3D scene, and are passed to a conditional image synthesis process as both text prompts and raster maps.

FIG. 4 is a functional block diagram illustrating one example of system for producing a rendering from a 3D model which integrates generative machine learning systems into computer-aided-design systems to support semantically-guided visualizations of 3D models. In brief, the system includes: 1) an approach of assigning semantic information to geometric elements of 3D models for the purposes of producing visualizations, including methods for assigning prompts to geometric elements at the texture, sub-object, and object levels, 2) the integration of text prompts as a way to determine environmental features of a 3D scene; 3) the integration of methods for the derivation of conditional image synthesis maps from 3D scenes; 4) methods for combining map-based and text-based information described in a 3D scene in preparation for conditional image synthesis.

Referring to FIG. 4, the system includes a geometric modeling module 115, a geometric model is created which may include 2D and/or 3D information, and the geometric descriptions that result 119 are passed on to subsequent processes. Since defining and composing the relationship of 2D and 3D geometric information is a critical aspect of the production of a visualization, this step proceeds identically to the traditional processes for producing visualizations of 3D models. These processes proceed differently in different domains, and depending on if the intended output is a single image, a sequence of images forming an animation, or an interactive system. The geometric modeling process is described in overview in a section above, and needs no further elaboration here.

In the semantic material assignment module 415, object, sub-object, and textural features are determined. This module proceeds differently from traditional processes, and is responsible for producing geometry with semantic information assigned 419 Here, a “semantic material” approach is employed, in which semantic information is embedded into the geometric elements of a 3D scene. This semantic information serves as the basis for the subsequent generation of a semantically-segmented raster map—a semantic map 438—that guides the generation of the rendering on a pixel-by-pixel basis. The data structures and functional user interface elements required for this step are discussed in the sections that follow.

In the camera configuration module 135, view-related features of the final rendering are determined. These features are encoded as a virtual camera 139, which are passed on to subsequent processes. In later processes, this virtual camera allows for the production of a number of maps that guide the production of the rendering on a pixel-by-pixel basis. The data formats and functional user interface elements required for this step are discussed in the sections that follow. Since view-related properties are an important point of compositional control for users across domains, this step proceeds identically to related processes in traditional visualization. These processes proceed differently in different domains, and depending on if the intended output is a single image, a sequence of images forming an animation, or an interactive system The camera configuration process is described above, and needs no further elaboration here.

In the environmental prompt module 425, those features of the 3D scene that are not directly related to 3D geometry are determined. This module calls for the environmental features of a 3D scene to be e pressed as text 429 that describes the overall lighting, mood, and style of the intended rendering. Here, a user interface enables textual information to be embedded into a 3D scene. This text is one factor that guides the generation of the rendering as a whole in subsequent processes.

In the map derivation module 435, given the information provided by preceding processes, a number of raster maps are derived that assert various forms of control over the conditional image synthesis process that follows. The maps produced by this module include a semantic map that encodes the semantic information determined in the semantic material assignment module 415. In some embodiments, a number of non-semantic maps may also be produced, such as edge maps and depth maps, derived from the combination of geometry created by the geometric modeling module 115 and the virtual camera 139 produced by the camera configuration module 135. 3D modeling systems are not traditionally designed to produce raster data intended to guide conditional image synthesis processes.

In the image synthesis module 445, render-process-based features are determined and a synthetic image is produced. Here, elements from previous steps are combined, weighted, and prepared for a GML-based image synthesis process. These elements include: the raster maps (both semantic 438 and no mantic 439) produced by the map generation module 435, as well as any text prompts that describe the overall lighting, mood, and style of the intended rendering 429. It should be noted that not all of these elements are required in every embodiment. Each element may be assigned a weight-a degree to which it influences the resulting visualization relative to other elements. These elements are combined to produce a package of information that guides the production of a synthetic image. The data formats and functional user interface elements required for this module are discussed in the sections that follow.

The various modules depicted in FIG. 4 which have not been previously described with reference to FIG. 1 will be described in more detail below.

### The Semantic Material Assignment Module

Within the semantic material assignment module 415, the identification of object, sub-object, and textural features takes place. Following a “semantic material” approach, this module distinguishes itself from conventional 3D visualization processes by associating geometry with semantic information in anticipation of the subsequent generation of a semantically segmented raster map 438 that takes place in a subsequent module 435. The primary function of this module is the association of textual information with geometric information in a 3D scene. For any given piece of geometry, this textual information will often take the form of a series of “prompts”—that is, a sequence of short phrases expressed in sequence—that describes the way in which the geometry is intended to be depicted. The association of prompts with 3D geometry may be expressed at three different levels—the object level, the sub-object level, and the texture level. These levels may be employed independently or in combination. A given embodiment may implement support for one level of material assignment, or for any combination of levels that work in concert. As detailed in the Map Derivation Module, semantic information expressed at any one level must be resolved against semantic information related to the same objects at other levels.

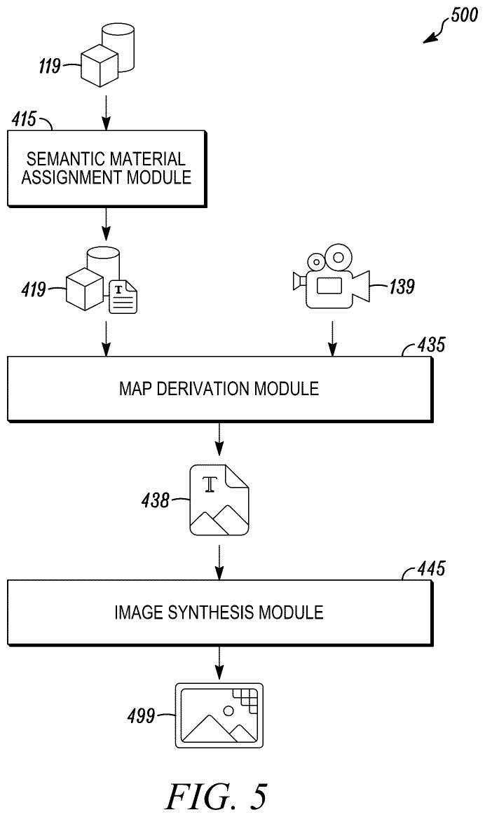

FIG. 5 is a functional block diagram illustrating an alternative embodiment of the visualization process shown in FIG. 4. This embodiment represents a minimal version of the visualization process to integrate generative machine learning systems into computer-aided design systems to support semantically-guided visualizations of 3D models.

While the systems and methods described herein are not limited to one domain, the set of modules described here considers the application domain of computer-aided design (CAD) and outlines how this functional module may be expressed in support of a typical design process. These modules may be configured differently in embodiments where the intended output is a sequence of images forming an animation, or an interactive system.

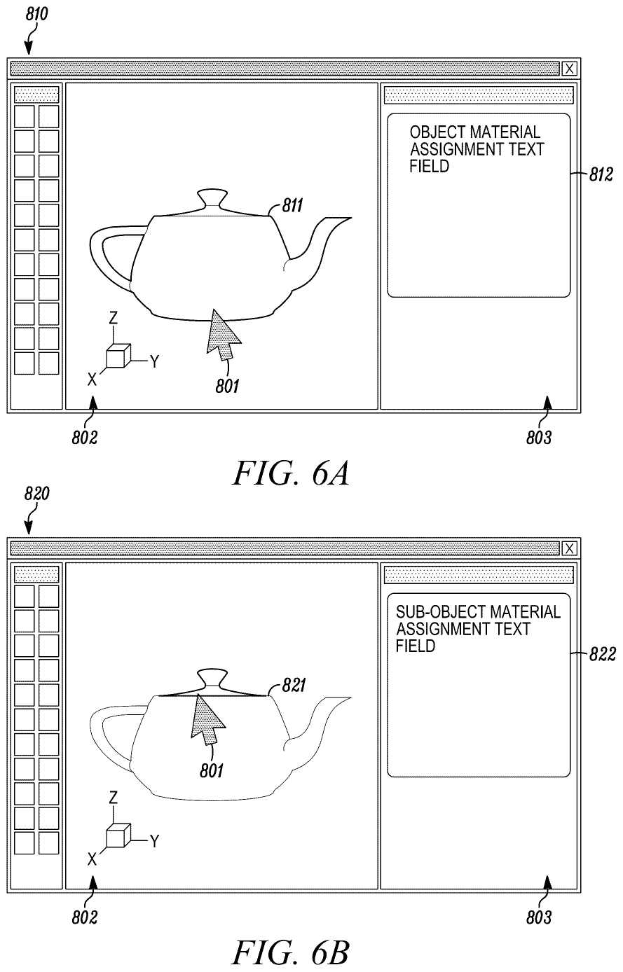

FIG. 6 illustrates user interfaces for two scenarios: the first scenario 810 exemplifies a user interface for the assigning of semantic information to 3D geometry at the object level; the second scenario 820 exemplifies a user interface for the assigning of semantic information to 3D geometry at the sub-object level. Note that this figure shows views of how the interface would appear to a user as they are in the process of assigning materials to 3D geometry—the viewport 802 represents an interactive area where a designer previews and manipulates geometric elements and does not represent the final rendering.

The object-level mode of this module activates in the scenario 810 that a single geometric object in a scene 811 is selected using the standard object selection mechanisms commonly employed by CAD systems. At this time, the properties panel 803 displays an interface element—the object material assignment text field 812—that enables the user to compose text that expresses the way in which the selected object should be visualized in the final rendering.

To illustrate the operation of this module at the object-level: a user might select a piece of geometry that represents a teapot in a CAD system, and enter the phrase “a teapot” in the object material assignment text field. In this scenario, the semantic map generated by the Map Derivation Module 435 would include a region that that resembles the figure of the teapot object, and that is related to the phrase “a teapot”.

The sub-object-level mode of the semantic material assignment module 415 activates in the scenario 820 that a geometric sub-object 821 in a scene is selected using the standard sub-object selection mechanisms commonly employed by CAD systems. At this time, the properties panel 803 displays an interface element—the sub-object material assignment text field 822—that enables the user to compose text that expresses the way in which the selected sub-object should be visualized in the final rendering.

To illustrate the operation of this module at the sub-object-level: a user might select a geometric sub-object that represents the lid of a teapot in a CAD system, and enter the phrase “wooden lid” in the object material assignment text field. They may then select a geometric sub-object that represents the body of this same teapot, and enter the phrase “hand-hammered copper” in the object material assignment text field. In this scenario, the semantic map 920 generated by the Map Derivation Module 435 would include two regions: one that resembles the figure of the teapot lid and that is related to the phrase “wooden lid”, and second that resembles the figure of the teapot lid and that is related to the phrase “hand-hammered copper”.

The semantic material assignment module 415 may also be used to assign textures. Texture mapping is a well-known method of defining the surface features of an object in anticipation of rendering, and that involves the application of a two-dimensional image, known as a “texture”, onto the surface of a 3D object such that each pixel in the raster image is related to a distinct geometric location on the target surface. A number of standard interfaces have been developed to facilitate the composing of this relationship, many of which include separate interfaces for interacting with a 3D view of the textured object in parallel with a 2D view of an “unwrapped” version of the surface of the object. Such interfaces often include: tools for unwrapping the object's surface and for adjusting the placement of texture coordinates, as well as related features like translation, rotation, and scaling that assist the user in fine-tune the mapping. Many CAD software packages provide an interactive “texture painting” interface that allow the user to define regions in the “unwrapped” 2D view that are then represented the textured 3D view of the object.

In some embodiments, an established “texture painting” interface is adapted to support the association of semantic information with 3D geometry at the texture level.

In some embodiments, the semantic material assignment module 415 is configured to allow user control of a degree of syntheticness for each geometric element. Syntheticness” is a point of control that allows a user to regulate the degree to which the traditionally rendered image is reflected in the synthetic image. This point of control may be applied 1) to the image as a whole, and 2) at the level of objects, sub-objects and texture present in the 3D scene. The latter case requires modification to the semantic material assignment module 415 to allow users to control the degree of “syntheticness” for each geometric element.

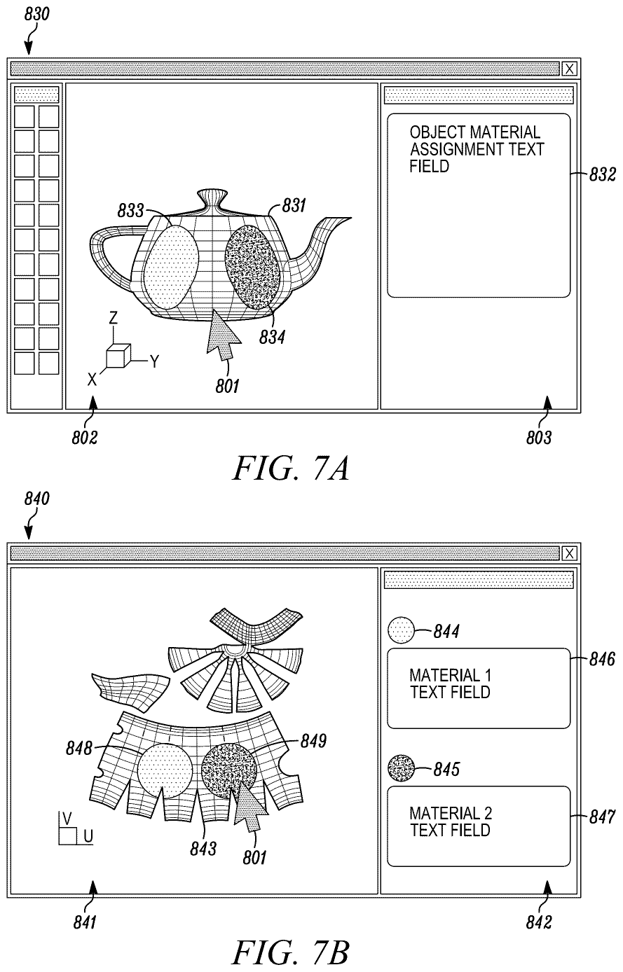

FIG. 7 illustrates user interfaces for a scenario in which a user assigns semantic information to 3D geometry at the texture level. Note that this figure shows views of how the interface would appear to a user as they are in the process of assigning materials to 3D geometry—the viewports 802 and 841 represent interactive areas where a designer previews and manipulates geometric elements and does not represent the final rendering. A grid is applied to the body of the teapot 831, 843 to show that the user is operating on the surface of this 3D object. The symbolic patterns shown in regions 833, 834, 844, 845, 848, and 849 represent colors in the user interface.

The texture-level mode of the semantic material assignment module 415 activates in the scenario 830 that geometric object in a scene 831 is selected using the standard object selection mechanisms commonly employed by 3D modeling systems, and the user indicates that they intend to operate on the object at the surface texture level. At this time, a second window of the 3D modeling application 840 is displayed. This window includes a 2D view 841 that shows an “unwrapping” of the surface of the selected object 843 alongside a new properties panel 842 that contains interface elements that enable the user to compose text that expresses the way in which certain regions of the selected object should be visualized in the final rendering. These interface elements include a number of color swatches 844, 845 each displayed next to a “material text field” 846, 847 that allows the user to compose text prompts. By activating one of the color swatches 844, 845, the user may use the cursor 801 in the 2D view 841 to “paint” the selected color onto the “unwrapping” of the selected object 843. Painted regions of this object appear both in the 2D “unwrapped” view 848, 849 and in their corresponding locations in the 3D view 833, 834. In this manner, any number of distinct prompt-region relationships may be defined, and any single prompt entered into one of the “material text fields” 846, 847 may be associated with more than one surface region of the selected object.

In parallel with the “texture painting” window 840, the main window of the application 830 may provide modifications to the properties panel 803 to display an interface element—the object material assignment text field 832—that enables the user to compose text that expresses the way in which the selected object as a whole should be visualized in the final rendering. Information expressed at the object level and the texture level may conflict. As is the case with any of the material assignment levels discussed in this section, semantic information expressed by the user at the texture level must be resolved against semantic information related to the same object at the object level. Resolving information expressed at these different levels is one of the functions of the Map Derivation Module 435.

To illustrate the operation of this module at the texture level: a user might select a piece of geometry that represents a teapot in a CAD system, and then indicate that they intend to operate on the object at the surface texture level. This action would activate the two-window user interface described above. The user may then compose a prompt in one of the material text fields 846 that reads “kintsugi cracks gold filled”, activate the related color swatch 844, and use their cursor 801 in the 2D view 841 to “paint” the selected color onto the “unwrapping” of the selected object 843 to define an area on the surface of the teapot object that is simultaneously displayed in both as a region 848 in the 2D unwrapped view 841 and as a region 833 in the 3D view 802.They may then enter a different prompt (e.g. “embossed floral design”) into a second material text field 847, and repeat this procedure.

Different embodiments may employ different data structures to store the semantic information produced by the semantic material assignment module 415. Any data structure employed for this purpose must: 1) relate geometric elements to user-defined textual data; 2) accommodate the nested structure of objects containing sub-objects (which may themselves contain sub-sub-objects, etc); 3) accommodate the assigning of text at the texture level. For example, a dictionary or map data structure (such as JSON) that stores key-value pairs may be employed. Here, the keys can represent references to geometric elements, and the values can hold the corresponding prompts. In the case of nested structures, these values can be dictionaries themselves forming a hierarchical structure. In the case of prompts assigned at the texture level reference to the appropriate texture map (described below) may be stored

To account for the assigning of text to geometric elements at the texture level, a texture map approach is adapted to accommodate semantic information. First, the user-defined text prompts related to texture are collected and stored as an ordered set of unique values. The index of a prompt in this set is termed the “prompt index” and is required in the next step. Then, geometric locations on the target surface are mapped to related pixels in a raster data structure. While a range of options exist to define this mapping (including texture coordinate arrays, texture coordinate buffers, texture coordinates embedded in polygon mesh data structures (such as half-edge), vertex texture mapping, and texture atlases), some embodiments may employ a standard UV mapping for this purpose—a widely used technique for associating 2D texture coordinates (u, v) with vertices of a polygon mesh. Any of a number of well-established approaches may be employed to establish a UV map for a given geometric element. These include manual unwrapping; projection of geometric primitives such as a plane, box, sphere, or cylinder; relaxation techniques, and projection painting. Rather than containing color information, the raster data structured mapped as texture coordinates would store a reference the appropriate “prompt index” established in an earlier step.

### The Environmental Prompt Module

The role of the environmental prompt module 425 is to determine those features of the final visualization that are not directly related to 3D geometry. This proceeds through the establishment of text prompts that describe the overall lighting, mood, and style of the intended rendering 429. In this module, a user or users supplies textual information that is stored in a 3D scene, and that serves as the basis for text prompts that guide the generation of the final visualization. The assignment of these prompts may proceed differently in different domains, and depending on if the intended output is a single image, a sequence of images forming an animation, or an interactive system. In an interactive system, such prompts may be defined both by the configuration of the interactive I actions performed by users of this system.

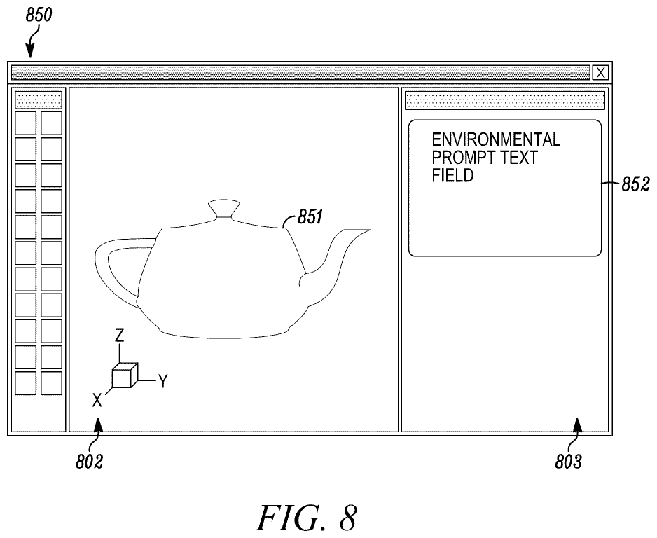

FIG. 8 illustrates a user interface for a scenario in which a user of a CAD system assigns semantic information to the overall environment described by a 3D scene. Note that this figure shows a view of how the interface would appear to a user as they are in the process of assigning materials to 3D geometry—the viewport 802 represents an interactive area where a designer previews and manipulates geometric elements, and does not represent the final rendering.

The environmental prompt module 425 activates in scenarios in which all of the 3D objects in a scene are unselected 850. At this time, the properties panel 803 displays interface elements that concern those features of the intended rendering not directly related to 3D geometry, These interface elements includes a text field 852 that is related to environmental or intangible properties of the intended scene, such as qualities related to the lighting, atmosphere, background, or other contextual features not explicitly related to geometric elements. For example, appropriate prompts expressed in this field may include phrases such as: “cinematic lighting” “landscape”, “high contrast”, “global illumination”, “portrait studio” “uplight”, “volumetric lighting”. Some embodiments may provide a separate text field intended for the user to enter text descriptions of factors that express the intended media or style of the final visualization. Prompts expressed in this field may include phrases such as: “panoramic view”, “soft focus”, “macro lens”, “chalk drawing”, “8-bit”, “35mm”, or “Polaroid”. In some embodiments, additional interface elements may be included that allow for user configuration of render-process related properties, such is image size, aspect ratio, other technical features that determine the way in which the image generation processes proceed.

### The Map Derivation Module

The role of the map derivation module 435 is to produce a number of maps that assert various forms of control over the conditional image synthesis process that follows. Two distinct categories of maps may be produced by this module: 1) a single semantic map 438 that relates regions of a raster image with textual prompts on a per-pixel level is produced via rasterization based upon the given 3D geometry with semantic information assigned 419; 2) a number of non-semantic maps 439 useful in the generation of synthetic images are produced using well-known rasterization and/or ray-tracing techniques. This module requires information from two prior processes: the Material Assignment Module 415 provides geometry that has been associated with semantic information 419, and the Camera Configuration Module 135 provides information concerning the desired point of view 139 encoded as a virtual camera.

In a given embodiment, the map derivation module 435 may produce different types of non-semantic maps, each of which may be useful in the generation of a synthetic image in Inter processes. In some embodiments, no non-semantic maps are produced, as the image synthesis process may proceed based solely on a semantic map. Note that the collection of possible maps enumerated herein is non-exhaustive, and other maps (e.g. normal maps) may be produced by this module.

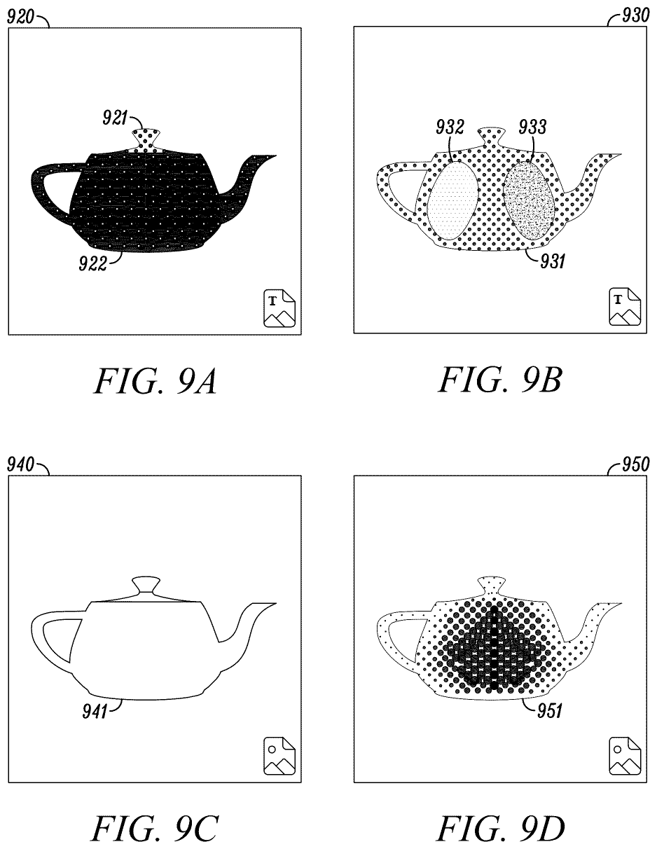

FIG. 9 illustrates four categories of maps that may be produced. The first category 920 is a semantic map containing two semantic regions defined through a sub-object-level assignment, each of which relates to a distinct sub-object of a common object. The second category 930 is a semantic map containing three semantic regions defined through texture-level assignment, each of which relates to a distinct region of a common object. The third category 940 is an edge map produced by traditional rendering processes. The forth category 950 is a depth map produced by traditional rendering processes. Note that the symbolic patterns shown in regions 921, 922, 931, 932, 933 represent regions of the semantic maps that are related to a different prompts—these regions may be visualized by different colors in a human-readable visualization of the semantic map. Also note that the patterns of dots shown in 950 represents greyscale values of the depth map.

As shown in FIG. 9, one type of non-semantic map is a depth map. In computer graphics, a “depth map”, also known as a depth buffer or Z-buffer, is a raster image 950 that stores per-pixel distance information of objects in a 3D scene relative to a virtual camera. Objects in a depth map 951 appear as regions of greyscale values that are related to the specific geometry of the object. Note that the patterns of dots shown in 950 is symbolic, and is meant to represent the greyscale values that would be seen in an actual depth map A depth map is typically calculated via a rasterization process: For each pixel in the viewport, the depth value is calculated by determining the distance between the camera and the corresponding object or point in the scene. This can be achieved by various well-established methods such as Z-buffering and ray casting, for example. In Z-buffering, a separate depth buffer or array is allocated for storing the depth values, and as each object is processed its depth is compared with the depth value already stored in the buffer for that pixel with the closer value stored; In ray casting, a ray is cast from the camera through each pixel, the intersection of the ray with objects in the scene is determined, and the distance between the c and the point of intersection is calculated.

One type of non-semantic map is an edge map. In computer graphics, edge rendering is a form of non-photorealistic rendering technique that creates raster representations 940 of 3D objects or scenes that resemble traditionally-illustrated line drawings 941. Instead of rendering objects with realistic shading and lighting, edge rendering focuses on emphasizing the edges or c tours of the objects To achieve edge rendering, various techniques can be employed. One approach is to extract 2D features such as silhouettes through an examination of the relationship of the form of objects in the scene to the virtual camera. Here, any point in the scene is understood to be on a silhouette line if the normal of the related object at that point is perpendicular to the view vector. A number of well-established implementations of this principle have been developed and integrated into the computer graphics pipeline. Another common approach is to use feature detection processes developed for computer vision applications. Here, an edge-detection algorithm operates on a raster image of a scene (such as a depth map or normal map) and identifies the edges or boundaries between different regions based on differences in color, intensity, or of light and shadow. Examples of edge-detection algorithms that may be include, for example, the Sobel-Feldmanh operator, Canny edge detection, the Harris corner detector, and the SUSAN comer detector.

In some embodiments, a traditionally-rendered image may be produced in the map derivation module 435 in order to guide the production of a synthetic image (e.g. serving as the initialization image in a machine learning-based image synthesis process). In many embodiments, the production of this rendered image may proceed as described in the conventional visualization process described above. In embodiments in which the systems and methods described herein are embodied as a plug-in to an existing CAD software, the traditionally-rendered image may rely on the rendering engine of the parent software.

One of the products of the map derivation module 435 is semantic map that is extracted from the same viewpoint as the non-semantic maps described above, and that is segmented in a way that reflects the semantic information embedded in a given set of 3D geometry 419. In text-guided conditional image synthesis, a semantic map is a raster data format that describes a segmentation of an image into visual regions, each of which is associated with a distinct textual prompt. As shown in FIG. 9, semantic maps² 920 and 930 may include subregions 921, 922, 931, 932, 933 that are each associated with a distinct text prompt. Note that the symbolic patterns shown in regions 921, 922, 931, 932, 933 represent regions of the semantic maps that are related to a different prompts-these regions may be visualized by different colors in a human-readable visualization of the semantic map.

Semantic segmentation as an approach to pixel-level classification is well-established in the field of computer vision and has been in use for several decades. In typical computer vision applications, semantic segmentation involves the assigning of a semantic label to each pixel in a given image, thereby segmenting the image into different regions based on their semantic meaning. 3D modeling systems themselves do not typically render semantic segmentation maps, since they do not contain the semantic labels required for segmentation. In the context of the systems and methods described herein, segmentation is possible due to the given geometry with semantic labels already applied, and is a significantly simplified task compared to typical computer vision applications.

This module produces a semantic segmentation map via the following steps:

First, the semantic information related to the geometric elements of the scene are accounted for, Any user-defined text associated with any geometric element in the scene at any level is extracted, disambiguated as described below, and stored as an ordered set of unique values. The index of a prompt in this set is termed the “prompt index” and is required in the rasterization process described below.

Next, the properties of the given virtual camera are used to define the viewpoint and perspective from which the scene will be rendered. The camera's position, orientation, field of view, and other needed sed as projection matrix that converts locations in the 3D scene to positions in a 2D viewport. This transformation maps the 3D coordinates of objects onto the 2D plane of the screen.

Finally, a basic rasterization is performed. As a well-established technique in computer graphics, rasterization proceeds in the conventional manner, but instead of assigning object colors to pixel values, the appropriate “prompt index” established in an earlier step is assigned. Here, each pixel of the viewport or image buffer is iterated through. For each pixel, the following steps are performed:
1. Projection: transform the 2D pixel coordinates to the corresponding coordinates in the scene's virtual space using the projection matrix derived from the given virtual camera.
2. Object Visibility: determine which objects in the scene, if any, are visible at the transformed pixel coordinates. This can be done using simple geometric intersection tests (e.g., bounding boxes) or complex algorithms such as z-buffering.
3. Prompt Index Assignment assign the appropriate “prompt index” of the visible object to the pixel in the image buffer. Retrieve the semantic information associated with the object and assign the related prompt index to the pixel value.

To produce a semantic map using the rasterization process described above, the map derivation module 433 includes a protocol to disambiguate and resolve conflicting semantic information expressed at different geometric levels. Prompts associated with geometry at one level must be resolved against prompts related to the same objects at other levels. To illustrate the disambiguation required, consider the following scenario. In the semantic material assignment module 415, a user may assign the prompt “a teapot” with a piece of gr At the object level, and also assign other prompts—e.g. the prompt “wooden lid” may be assigned to one sub-object, and the prompt “hand-hammered copper” may be assigned to another—at the sub-object level. In such a scenario, two different approaches may be taken to resolve the conflict: 1) the prompts assigned at different levels may be combined to create new composite prompts; 2) one level of prompt assignment may take precedence over another. If the former method is applied, a number of composite prompts could be expressed in the resulting semantic map. In the teapot example discussed above, this first approach may be illustrated by a semantic map 920 that includes two regions: one region 921 would be associated with the composite prompt “a teapot; wooden lid”, while the other region 922 would be associated with the composite prompt “a teapot; hand-hammered copper”. In contrast, if the latter method is applied, only prompts directly composed by the user would be expressed in the semantic map, with higher- or lower-level prompts overriding others. To illustrate this approach, consider a similar example. Here, in the semantic material assignment module 415 the user has assigned the prompt “a Japanese redware teapot” at the object level, and the following two prompts have been assigned to two separate regions at the texture level: “embossed floral design”, and “kintsugi cracks gold filled”. In this case, the resulting semantic map 930 would be generated with three regions: a single region 931 would be as sociated with the prompt “a Japanese redware teapot”, and would contain two smaller regions 932, 933 that are respectively associated with the prompts “embossed floral design”, and “kintsugi cracks gold filled”. Depending on the embodiment, either of these two methods for resolving prompts at different levels may be employed, or the selection of the appropriate method may be determined by the user.

### The Image Synthesis Module

The role of the image synthesis module 445 is to produce a synthetic image given information provided by previous modules. In preparation for a GML-based image synthesis process, given inputs to this module are combined, weighted, and packaged in a manner required by conditional image synthesis. In some embodiments, additional settings and configurations may also be required when this module is activated. There are a number of approaches to conditional image synthesis that may be regarded as state-of-the-art, and that may be employed by different embodiments of the subject matter described herein. As such, we describe here the operation of this module in terms of the requirements of three functional sub-modules. The first combines and weights information provided by previous modules, and prepares this information in the format required by conditional image synthesis systems. The second collects user-provided data that may be used to configure the process of conditional image synthesis. The third accounts for the image synthesis process itself, which may be handled by any of a number of existing conditional image synthesis systems that satisfy a set of functional requirements. The product of this module is a synthetically-rendered image.

The image synthesis module 445 accepts information produced by previous modules, and prepares this information for use by a conditional image synthesis process. The input data required by this module is prepared and weighted in the following sub-modules.

Prompt Preparation Sub-module: this sub-module prepares any text 429 produced by the Environmental Prompt Module 435 that describes the overall lighting, mood, and style of the intended rendering 429 In any conditional image synthesis system, text must be properly represented before being passed to subsequent steps. This process may involve: 1) text tokenization, wherein a longer string of text is broken into its constituent words or sub-words; 2) word embedding, wherein each token produced by the previous process is mapped to a high-dimensional vector using a word embedding routine (e.g., Word2 Vec, GloVe, FastText, and an analogous process using a transformer-based language models such as GPT); 3) text encoding wherein the vector produced by the previous process is translated into a vector of fixed length expected by subsequent steps. In some embodiments, any text referred to by a semantic map must also appear in the text prompt given to the conditional image synthesis system, In those cases, this sub-module extracts text from the given semantic map and appended to the prompt provided by the Environmental Prompt Module prior to the steps described above.

Non-Semantic Map Preparation Sub-module: this sub-module prepares any non-semantic maps 439 produced by the Map Derivation Module 435, such as a depth map or an edge map, that describe certain non-semantic features of the intended rendering. In any conditional image synthesis system, raster data must be properly represented before being passed to subsequent steps. This process may involve: 1) resizing, wherein the raster data provided is resized to match the input dimensions expected by the model using standard image manipulation techniques; 2) normalization, wherein the values contained within the raster data provided is remapped from whatever range was provided to the range expected by the specific architecture and activation functions used in subsequent steps. For example, the range provided by a raster image is often from 0 to 255, where range expected is typically from 0 to 1 or from −1 to 1.

Semantic Map Preparation Sub-module: this sub-module prepares the semantic map 438 produced by the Map Derivation Module 435 that describes subregions of the intended rendering, each of which are each associated with a distinct text prompt. This process proceeds in much the s he way as non-semantic maps. In embodiments that employ conditional image synthesis systems that require semantic map-related text appear in the primary prompt, text may be extracted from the given semantic map and appended to the prompt provided by the Environmental Prompt Module as described above.

Each input data may be assigned a weight—a degree to which it influences the resulting visualization relative to other elements. In some embodiments, this weighting may be hard-coded as a part of the implementation of the embodiment, or may be determined by the user via a user interface provided by the embodiment. Some embodiments may allow a user to define additional settings and points of control in the image synthesis process. These settings may be determined by the user and entered via a user interface that is provided.

Technological advances in generative image synthesis proceed quickly, with new approaches—and refinements to existing approaches—developed at a rapid pace. As such, the combined text-and-image conditional image synthesis process that is required by this module may proceed through any of a number of recently-established processes, so long as the functional requirements outlined below are met. These may include systems built upon Generative Adversarial Networks (GANs), Variational Antoencoders (VAEs), autoregressive models, Diffusion models, and any other conditional image synthesis systems that fulfill the stated requirements. The functional requirements of this sub-module are:
The sub-module may accept text data as an input, and use this data as one factor that guides the generation of a synthetic image. In many systems, as described above, this proceeds through the separation of text into smaller units called “tokens”, and the encoding of these tokens as latent vectors.
The sub-module must accept a semantic map as an input and use this data as one factor that guides the generation of a synthetic image. In GML, the use of a semantic map in this manner is alternatively understood as an image-to-image translation task, or as a task intended to control an image generation process with task-specific conditions.
The sub-module may accept non-semantic maps (e.g. edge maps, depth maps) as an input, and use this data as one factor that guides the generation of a synthetic image. In GML, the use of non-semantic maps in this manner is understood in much the same way as semantic maps, as described above.
The sub-module may allow each input described above to be assigned a weight—a degree to which it influences the resulting visualization, described relative to the weights of other inputs.

As an example, one embodiment of this submodule may employ ControlNet, which is a modification of the foundational model Stable Diffusion and state-of-the-art map-guided conditional image synthesis system. This system satisfies the functional requirements described above, and would represent an appropriate selection for this component.

As previously mentioned, in some embodiments the rendering system of the present disclosure may be embodied as a plug-in to an existing 3D modeling software application. In this embodiment certain aspects of the system may draw from features of the parent software. For example, the CAD software Rhinoceros p de mechanisms for defining and configuring virtual cameras, which would fulfill requirements called for by the camera configuration module 135; the 3D modeling software Blender provides mechanisms for producing semantic maps from geometric elements in a scene, which would partially fulfill requirements called for by the map derivation module 435; the CAD software Revit provides mechanisms for assigning data (which may include text prompts) to geometric elements in a scene, which would partially fulfill requirements called for by the semantic material assignment module 415.

In yet other embodiments, one or more (or all) of the modules may be implemented as cloud service hosted on one or more remote servers. For example, the image synthesis module 445 may be configured as a cloud service, with related functionality delivered over the internet and the module hosted on remote servers. In this embodiment, each time a rendering is required, all information required for the module to operate would be transmitted, the module would execute on a remote server, and the resulting rendering would be transmitted back to the user over the internet.

In another embodiment, at least one of the modules may be configured as a standalone software application. In this embodiment, two files expressed in any number of appropriate file formats are imported into a software application: a 3D model 119 and a description of the intended view expressed as the properties of a virtual camera 139. Functionality related to all subsequent modules are then provided within the standalone software application. In order to support the generation of a coherent sequence of renderings. such as in the context of creating an animation, in some embodiments the user-provided geometric model 119 and the user-provided virtual camera 139 include descriptions of transformations in these elements over time. In this embodiment the map derivation module 435 is configured to produce one of each relevant map for each time-step required. Likewise, the image synthesis module 445 is configured to accept a new optional input that guides the production of a synthetic image that represents an immediately proximate frame in the animation. The inclusion of this. input allows for new renderings to be generated that are as close as possible to nearby frames in an animation.

In some embodiments the geometric model 119 and the virtual camera 130 are configured to accept real-time user input to thereby support the generation of renderings for an interactive interface with a 3D model such as in the context of a video game or interactive display. In these embodiments the semantic material assignment module 415 is configured to assign semantic materials to a rigged 3D geometry that is to be animated by an end user. The map derivation module 435 and the image synthesis module 445 are configured to run on an interactive device controlled by the end user.

### Terms and Definitions

The subject matter described herein pertains to two related fields—3D computer graphics and generative machine learning. As each field has its own technical language that may not be familiar to individuals from another field, in the interest of clarity provided below is a list of terms and definitions found in each field. Some of the terms below are not widely used and are related specifically to the present disclosure.

The following terms are related to the field of 3D computer graphics.

### 3D Model

A geometric digital representation of three-dimensional objects, sub-objects, and environments in a given data structure. These representations typically employ a system of Cartesian coordinates to describe various geometric entities such as vertices (points), lines, faces, polygons, solids, and NURBS-based curves and surfaces. A 3D model may also describe a set of virtual materials, and account for the relationship of geometric objects with these materials. 3D modeling software (such as CAD software) offers a user interface for interacting with a 3D model, which typically includes mechanisms for authoring and editing geometric descriptions, interfaces for configuring and assigning materials to geometry, and ways to display basic views of a 3D model. If a 3D model contains only a description of geometry, and does not define a set of virtual materials, then the terms “geometric model” and “3D model” may be used interchangeably

### 3D Scene

A 3D model in combination with a number of non-geometric elements that affect the manner in which the 3D model is imaged. In contrast with a 3D model on its own, a 3D scene contains a more comprehensive body of information required for the production of a rendering. Among the additional elements included in a scene are: a set of virtual materials defined in relationship to the given 3D geometry (if not already defined in the 3D model); a virtual camera that determines the point of view from which the scene is imaged; a set of virtual lights such as point lights, area lights, and global illumination; other settings that affect the way in which a 3D model is imaged, such as an environment map, properties related to atmospheric effects; and properties related to lighting effects such reflections, refractions, and caustics.

### Geometric Model

A term that refers specifically to the geometric portion of the 3D model, in which geometric elements (including objects, sub-object and geometric descriptions at other levels) are defined in a given data structure. The act of creating a geometric model is termed “geometric modeling”. If a 3D model contains only a description of geometry, and does not define a set of virtual materials, then the terms “geometric model” and “3D model” may be used interchangeably.

### Rendering

The process of producing an image from a 3D scene. This process involves a series of algorithms that may simulate the scene as it would appear in real life, or may produce a non-photorealistic image. The image that results is a digital representation of the given scene from a certain point-of-view, which may be expressed through a variety of graphic projective systems including perspectival or orthographic.

### Virtual Camera

A central concept in the rendering process, a “virtual camera” is a data structure that stores the necessary information (including both geometric transformations, as well as other data) to convert a 3D scene into a 2D image. The central function of the virtual camera is to encapsulate two primary transformations, typically stored as 4×4 vector matrices, that map points from the 3D world onto a 2D plane: 1 ) The “viewing transformation” represents the position and orientation of the camera in the 3D world, thereby specifying where the camera is and where it is looking; 2) the “projection transformation” takes 3D coordinates from a 3D model and maps them onto the 2D plane of the rendered image—a process known as projection. The two primary systems of projection used in this context are perspectival projection and orthographic projection. Besides transformation data, a virtual camera may store other properties that influence how these transformations are constructed and therefore how the final rendered image appears. These properties include Field of View (FOV), aspect ratio, clipping planes, aperture size, and focus distance. Some of these—such as FOV and aspect ratio—are used directly in defining the transformation matrix (in this case, for a perspective projection), while others—such as depth of field—are related to more complex rendering techniques that simulate the path of light through the scene.

### Virtual Material

A collection of properties and various forms of data that is associated with 3D geometry, and that describes the manner in which this geometry appears in a rendering. Properties include those factors that can be expressed through single values that are applied across an object or sub-object, such as: diffuse color, specularity, emission, transparency/opacity, and reflectivity. Other properties may change across a given surface, such as a pattern of color or texture These properties are assigned at the level of “texture”, and are described as a 2D image (the texture) that is wrapped onto the surface of a given 3D object. The specific properties that constitute a virtual material vary from software to software, and also depends on the specific rendering engine being used.

The following terms are related to computer science in general, and from generative machine learning contexts in particular.

### Image

A special case of raster data in which each pixel contains a color, and that is arranged and interpreted to create a picture viewable by a person For purposes herein, raster data refers to an “image” only in cases that raster data is intended to be viewable by a person.

### Image Synthesis

In generative machine learning, “image synthesis” is the process of generating new images that could conceivably be real, even though they are entirely generated by a machine. An image produced by this process is termed a “synthetic image”.

### Map

In the context of conditional image synthesis systems, a “map” is input raster data that offers various forms of control over the generation of an image. Examples include depth maps, edge maps, normal maps, and semantic maps. Some maps, such as depth maps and edge maps, are visually legible to people, and may be referred to as “images”. Others, such as semantic maps, are not directly legible, but may be translated into visually meaningful images. For the purposes herein, the term “map” only refers to raster data intended to guide a conditional image synthesis process.

### Non-Semantic Map

As used herein, this term refers to any map that is not a semantic map.

### Prompt

In the domain of generative machine learning, a “prompt”denotes a sequence of textual input data that is given to a generative model to guide subsequent output generation. In typical GML processes, the given prompt is tokenized and then encoded into a numerical format, typically a high-dimensional vector, that the model can process. Each token may represent a character, a word, or a subword, depending on the model's design. Once encoded, this vector is passed through the model's lavers, each of which applies a set of transformations (determined by the model's learned parameters) to the data. The final layer of the model then decodes the transformed vector into the desired output.

### Raster Data

A two-dimensional data structure, or array, composed of individual elements that can contain various forms of information. Raster data is used to represent spatial data, such as images. When used in this way, each element in the two-dimensional array is referred to as a “pixel” (or picture-element).

### Semantic Information

In computer science, “semantic information” refers to a higher-level meaning or understanding related to a given form of data, and that aids the processing of this data in a way that's closer to its intended use As used herein, the term “semantic information” in the context of the association of 3D geometric elements with user-provided text descriptions of what these objects are meant to represent when visualized in renderings. While this use is similar to that of a straightforward “prompt”, a different term is employed herein in that text is stored and processed differently in the present system. Here, text descriptions of geometric elements may be assigned at the object, sub-object, and textural levels, and must be disambiguated and resolved before being encoded into a semantic map based upon a 3D scene. We use the term “semantic information” specifically to refer to textual data that is stored in a format that allows for associations to be expressed at these levels.

### Semantic Map

In the context of conditional image synthesis systems a “map” is input raster data that represents a spatial distribution of semantic information over an image or a scene. It is commonly used in computer vision tasks such as scene understanding, segmentation, and object recognition. A semantic map typically consists of a 2D array of pixels, with each pixel assigned a label or category that represents the semantic meaning of the corresponding region. The labels can indicate objects, classes, or other semantic concepts.

### Semantic Material

As used herein, this term describes semantic information that is embedded into the geometric elements of a 3D scene, and that describes how these elements are intended to appear in a rendering. This term is used in the context of existing approaches t rendering 3D models, and in contrast to traditional “materials” in 3D graphics, which describe the intended appearance of geometric elements in terms of the configuration of a set of predetermined properties (e.g., diffuse color, reflectivity, translucency, etc).

### Synthetic Image

In generative machine learning, a “synthetic image” is an image produced via image synthesis see above).

### Text/Textual Data

A sequence of characters that can be interpreted as a form of written language. Text can be stored, manipulated, and displayed using a variety of data formats and encoding systems, such as ASCII and Unicode. Text can be structured in a variety of ways to be machine-readable and interpretable by computers. The structure of text data can range from highly structured formats (e.g. HTML, XML, JSON), to semi-structured data (e.g. CSV), to less structured formats like prompts for generative machine learning applications.

### Illustrative Computing Environment

Aspects of the subject matter described herein may be described in the general context of computer-executable instructions, such as computer programs, being executed by a computer or a cluster of computers. Generally, computer programs include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory devices

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, system or article of manufacture using standard prog engineering techniques to produce software, firmware, hardware, or any combination thereof to control a computer to implement the disclosed subject matter, For instance the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

As used herein the terms “software,” computer programs,” “programs,” “computer code” and the like refer to a set of program instructions running on an arithmetical processing device such as a microprocessor or DSP chip. or as a set of logic operations implemented in circuitry such as a field-programmable gate array (FPGA) or in a semicustom or custom VLSI integrated circuit. That is, all such references to “software,” computer programs,” “programs,” “computer code,” as well as reference to various “engines” and the like may be implemented in any form of logic embodied in hardware, a combination of hardware and software, software, or software in execution. Furthermore, logic embodied, for instance, exclusively in hardware may also be arranged in some embodiments to function as its own trusted execution environment.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process run a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

1. A system of producing a rendering from a 3D model, comprising:
a semantic material assignment module that, when executed by one or more processors, receives a user-provided geometric model, and assigns semantic information to elements of the geometric model based on textual user input data;
a map derivation module that, when executed by one or more processors, receives the geometric model with semantic information assigned, and receives a user-provided virtual camera, produces a semantic map; and
an image synthesis module that, when executed by one or more processors, receives the semantic map, and produces a synthetic image using a conditional image synthesis process, based on user input data.

2. A system for producing a rendering from 3D models, comprising:
a geometric modeling module for producing a geometric model based on first user input data;
a semantic material assignment module that, when executed by one or more processors, receives the geometric model, and assigns semantic information to elements of the geometric model based on textual user input data;
a camera configuration module that, when executed by one or more processors, receives the geometric model, and produces a virtual camera based on user input data;
a map derivation module that, when executed by one or more processors, receives the geometric model with semantic information assigned, and receives the virtual camera, and produces a semantic map and produces one or more supplemental non-semantic maps such as a depth map, edge map, a ad/or a traditionally-rendered image;
an environmental prompt module that, when executed by one or more processors, produces a prompt that describes the general style-based features to be reflected in the rendering, such as the overall lighting, mood, and style, based on user input data; and
an image synthesis module that, when executed by one or more processors, receives the semantic map, the supplemental non-semantic maps, and any prompts, and produces a synthetic image using a conditional image synthesis process, based user input data.

3. The system of claim 2, wherein the system is configured at least in part as a plug-in to a 3D modeling software application.

4. The system of claim 1, wherein at least one of the modules is configured at least in part as a cloud service hosted on remote server.

5. The system of claim 1, wherein at least one of the modules is configured as a standalone software application.

6. The system of claim 1, wherein the semantic material assignment module is configured to assign semantic information to elements of the geometric model via an interface that permits users to virtually paint directly on a 3D surface of geometric elements.

7. The system of claim 1, wherein the semantic material assignment module is configured to assign semantic information to elements of the geometric model by importing a predefined indexed color image and assign for each color contained therein.

8. The system of claim 1, wherein, rather than operating using an unwrapped 2D view, the semantic material assignment module is configured to relate pixels in raster data to geometric locations on a target surface through the projection of geometric primitives.

9. The system of claim 1, wherein the map derivation module is configured to produce a plurality of maps of different types, one of the maps being usable to guide production of the synthetic image.

10. The system of claim 9, wherein the semantic material assignment module is configured to allow user control of a degree of syntheticness for each geometric element.

11. The system of claim 2, wherein the geometric model and the virtual camera are configured to include descriptions of transformations over time to thereby support generation of renderings, the map derivation module being configured to produce one of each relevant map for each time-step required, and the image synthesis module being configured to accept a new optional input that guides production of a synthetic image that represents proximate frame(s) in the sequence of renderings.

12. The system of claim 11, wherein the geometric model and the virtual camera are configured to accept real-time user input to thereby support the generation of renderings for an interactive interface with a 3D model, the semantic material assignment module being configured to assign semantic materials to a rigged 3D geometry, with textual prompts provided by the system developer or the end user, the map derivation module and the image synthesis module being configured to run on an interactive device controlled by the end user.

13. The system of claim 2, wherein the geometric modeling module is expressed as an interactive model or is a result of an associated interactive system.

14. The system of claim 2, wherein the semantic material assignment module is configured to assign semantic information interactively to elements of the geometric model based on textual input data received from different users.

15. The system of claim 14, wherein the different users include a developer of the geometric model and an end user.

16. The method of claim 15, wherein the image synthesis module is configured to operate on a sequence of inputs and produce a sequence of outputs in coordination therewith.
